(19) United States
(12) Patent Application Publication
(10) Pub. No.: US 2005/0186352 A1
(43) Pub. Date: Aug. 25, 2005

(54) Method for treating wood

(76) Inventors: G. Frederick Hutter, Charleston, SC (US); Michael Alan Lake, Mount Pleasant, SC (US); David Lawrence Smith, Charleston, SC (US); Philip Leslie Robinson, Isle of Palms, SC (US); Frederick Eugene Bishop JR., Charleston, SC (US)

Correspondence Address: MEADWESTVACO CORPORATION, REGIONAL OFFICE BUILDING, PO BOX 118005, CHARLESTON, SC, 29423-8005, US

(21) Appl. No.: 10/998,776

(22) Filed: Nov. 29, 2004

Related U.S. Application Data
(60) Provisional application No. 60/546,293, filed on Feb. 20, 2004.

(51) Int. Cl. B05D 1/18

(52) U.S. Cl. 427/430.1

(57) ABSTRACT

This invention relates to a method for treating wood and the treated wood. More particularly, the invention relates to a wood treatment method for making wood resistant to insect and soil microbe damage by impregnating the wood with a mixture of at least one borate and at least one rosin and/or rosin derivative.

This non-provisional application relies on the filing date of provisional Application Ser. No. 60/546,293, filed on Feb. 20, 2004, having been filed within twelve (12) months thereof, which is incorporated herein by reference, and priority thereto is claimed under 35 USC § 1.19(e).

### FIELD OF INVENTION

This invention relates to a method for treating wood and to the treated wood. More particularly, the invention relates to a method for making wood resistant to insect and soil microbe damage by impregnating the wood with a mixture of at least one borate and at least one rosin and/or rosin derivative.

### BACKGROUND OF THE INVENTION

Essentially all wood, as a natural material, is susceptible to damage by insects and soil microbes, unless treated therefore. For many years wood that is to be used in applications where it is exposed to attack by insects or soil microbes has been pressure-treated with chromated copper arsenate (CCA). Due to its arsenic content, CCA is now being banned for use in applications where humans are likely to come into direct contact with the treated wood. Such applications include decking and playground equipment.

A number of alternative, non-arsenical pesticidal treatments containing heavy metals (primarily copper) have been proposed. For example, U.S. Pat. No. 4,929,454 teaches the treatment of wood with a mixture of a copper compound and a quaternary ammonium compound. This technology has been commercialized under the name ammoniated copper quat (ACQ). It has excellent insect resistance, but it is considerable more costly than CCA and it has a tendency promote the growth of white mold on the wood surface. Furthermore, ACQ-treated wood may exhibit corrosion problems with most metal fasteners. Also, the use of heavy metals in the treatment of wood may lead to various environmental concerns.

It has long been known that borates (i.e., boric acid and its salts) exhibit excellent insecticidal and fungicidal properties, while having negligible mammalian toxicity. They should, therefore, be almost ideal for wood treatment. However, boric acid and its water-soluble salts (such as borax, disodium octaborate tetrahydrate, and the like) are extremely mobile in wood in the presence of water. Repeated exposure to rain water leaches these borates from wood very rapidly. This is a problem because it is desirable that wood used for decking and similar outdoor construction maintain its insect resistance for at least 15 years, preferably 30 years or more.

A number of methods have been proposed to decrease the mobility of borates in the wood by chemical binding. One method is to bind the borate as a water-insoluble salt of a polyvalent metal. For example, U.S. Pat. Nos. 1,346,830, 1,994,073, 2,194,827, 2,895,848, 4,857,323, and 5,207,823 teach binding of the borate in the wood as an insoluble copper or zinc salt. U.S. Pat. No. 3,007,844 discloses the use of a chromate salt in addition to the copper or zinc borate. U.S. Pat. No. 5,478,598 discloses the use of a silicate in addition to the zinc or copper borate. U.S. Pat. No. 5,612,094 discloses the use of zirconium borate.

Another method is to insolubilize the borate in the form of an alkylammonium salt. U.S. Pat. Nos. 5,641,726, 5,700,841, 5,855,817, 5,891,921, and 6,087,303 all teach the use of alkylammonium borates in wood treatment. U.S. Pat. No. 5,304,237 discloses bonding the borate in the wood as a boric ester containing quaternary ammonium groups. U.S. Pat. No. 5,087,457 teaches the use of borate salts of ionenes, which are polymers containing quaternary ammonium groups.

U.S. Pat. No. 5,061,698 discloses the use of alkylamine boratres in wood treatment

U.S. Pat. No. 6,508,869 discloses fixing the borate in the wood by use of a tertiary amine oxide.

U.S. Pat. Nos. 6,235,349 and 6,528,175 teach the use of a silicate as a means of fixing the borate in the wood. U.S. Pat. No. 6,146,766 also discloses the fixation of borates in wood using silicates.

U.S. Pat. No. 4,354,316 discloses the use of trimethyl borate in the vapor phase to form boric esters in situ in the wood.

However, the problem with these methods is that even the most water-insoluble borates, boric esters, and borate complexes will, on prolonged contact with water, hydrolyze to form boric acid which will leach out of the wood. For example, experimental data show that zinc borate in wood hydrolyzes rapidly to zinc oxide and boric acid. Elemental analysis shows that the resulting zinc oxide stays in the wood, while the boric acid is almost immediately removed by leaching. (Reference: Laks, P. B., and Manning, M. J., “Mobility of Zinc Borate Wood Composite Preservative,” Proceedings of the 28^{th} Annual Meeting of the International Research Group on Wood Preservation, Whistler, Canada, 25-30 May, 1997). At the same proceedings, A. Peylo and H. Willeitner, in “Leaching of Boron—more than 3 years of field exposure,” teach that leaching of Boron can be diminished but not prevented by thin surface coats like varnishes. Of course, the contact of outdoor wood structures with water can be considerable in wet climates (such as those normally found in the Southeastern United States, the Pacific Northwest, and Hawaii).

U.S. Pat. No. 4,276,329 discloses a method of enhancing the dimensional stability of wood by swelling and impregnating the cell walls of the wood with a solution of low molecular weight polymer in water and water-miscible solvent. It also teaches that additives such as borates can be carried into the cell walls along with the polymer. In this method, the water-miscible organic cosolvent is a disadvantage for environmental reasons. It would be desirable to have a resinous material that would fix the borate in the wood without the necessity of using such a solvent.

The present invention offers an alternative mechanism for fixing borate compounds in wood, that of making the wood so hydrophobic that water can not enter the wood in sufficient amount to leach out the borate. It is well known in the art that the surface of wood can be rendered hydrophobic by coating it with paints, varnishes, waxes, and similar materials. However, doing so can be labor-intensive and relatively costly. Applying a traditional hydrophobic coating at the wood mill, as is often done with railroad ties or telephone poles, is much less labor-intensive than painting or varnishing. However, lumber used in construction is usually cut, drilled, routed, and otherwise machined in the course of its use, which would tend to breach such traditional factory coatings, allowing water penetration.

Therefore, it is an object of the present invention to disclose a method for pressure treating wood.

Another object of the present invention is to provide a method for making wood resistant to damage caused by soil microbes and/or insects by pressure treating the wood with a borate and rosin and/or rosin derivative mixture.

A further object of the present invention to produce pressure treated wood which is hydrophobic throughout so that it can be machined and still maintain its hydrophobicity.

A further object of the invention is to provide such a treatment without the use of environmentally hazardous organic solvents.

Other objects and advantages of the present invention will become apparent from the following detailed description.

### SUMMARY OF THE INVENTION

The objects of this invention are met by a method that impregnates wood with an aqueous liquid dispersion which contains at least one borate and at least one rosin and/or a rosin derivative, thereby simultaneously incorporating borate into the wood and rendering the wood hydrophobic so the water will not readily penetrate it and leach out the borate. The impregnation of the wood with the resinous component serves to effectively retard the leaching of the biocidal borate from the wood.

### DESCRIPTION OF THE PREFERRED EMBODIMENT

A method of the present invention for producing wood that is resistant to insects and soil microbes, comprises the step of immersing insect- and soil microbe-susceptible wood in an aqueous liquid dispersion, wherein the non-volatile content of the aqueous liquid dispersion comprises:
(a) from about 10% to about 90% by weight of at least one borate, and
(b) from about 90% to about 10% by weight of a resinous component comprising at least one member selected from the group consisting of rosin, rosin derivatives, and combinations thereof,
   for a time sufficient to impregnate the wood with a biocidally effective level of borate (i.e., a period of time sufficient to allow a biocidally effective level of borate uptake into the wood).

Wood which is suitable for use in the present invention may be of any species that is commercially pressure treated for use in outdoor construction. Preferred woods include pine, fir, spruce, and hemlock. It is preferred that the wood employed in the present invention be a wood part. In the context of the present invention the term “wood part” relates to any wooden article that used in construction, particularly those articles that are subject to outdoor exposure (such as decking, facia boards, exterior grade plywood, construction elements for outdoor furniture or playground equipment, fencing, and the like).

Borate comprises from about 10% to about 90% (preferably from about 30% to about 70%) by total weight of the non-volatile content of the aqueous liquid dispersion of the present invention. Borates that are suitable for use in the current invention include boric acid, borate salts, borate esters, and mixtures thereof. Examples of these borates are described in the Kirk-Othmer Encyclopedia of Chemical Technology, 4th Edition, Vol. 4, pp 365 to 423, which is incorporated herein by reference.

As used herein the term “biocidally effective” means the minimum amount of borate necessary to kill the targeted insects or soil microbes. For example, it is generally accepted in the North American wood treating industry that about 0.17 lb/ft³ of B₂O₃ or about 1,350 ppm of boron in the wood represents a minimum level of borate needed effectively to kill termites. It is well within the ability of those skilled in the art to utilize the method of the present invention to produce wood that is impregnated with a desired biocidal level of borate.

The resinous component of the present invention comprises at least one member selected from the group consisting of rosin, rosin derivatives, and combinations thereof. The resinous component comprises from about 10% to about 90% (preferably from about 30% to about 70%) by total weight of the non-volatile content of the aqueous liquid dispersion of the present invention.

Rosins that are suitable for use in the present invention include tall oil rosin, gum rosin, wood rosin, and combinations thereof. Rosin derivatives that are suitable for use in the method of the invention include, but are not limited to, the following: hydrogenated rosins, disproportionated rosins, formaldehyde-treated rosins, dimerized rosins, polymerized rosin, fumarated rosins, maleated rosins, styrenated rosins, phenolic-modified rosins, acrylic-modified rosins, hydrocarbon-modified rosins, rosin-vinylic copolymers, rosin salts, hydrogenated rosin salts, disproportionated rosin salts, formaldehyde-treated rosin salts, dimerized rosin salts, polymerized rosin salts, fumarated rosin salts, maleated rosin salts, styrenated rosin salts, phenolic-modified rosin salts, acrylic-modified rosin salts, hydrocarbon-modified rosin salts, rosin-vinylic copolymer salts, rosin esters, hydrogenated rosin esters, disproportionated rosin esters, formaldehyde-treated rosin esters, dimerized rosin esters, polymerized rosin esters, fumarated rosin esters, maleated rosin esters, styrenated rosin esters, phenolic-modified rosin esters, acrylic-modified rosin esters, hydrocarbon-modified rosin esters, rosin-vinylic copolymer esters, rosin amides, hydrogenated rosin amides, disproportionated rosin amides, formaldehyde-treated rosin amides, dimerized rosin amides, polymerized rosin amides, fumarated rosin amides, maleated rosin amides, styrenated rosin amides, phenolic-modified rosin amides, acrylic-modified rosin amides, hydrocarbon-modified rosin amides, rosin-vinylic copolymer amides, and combinations thereof. Many such rosin derivatives are commercially available, being used in the manufacture of inks, adhesives, paper sizes, and the like. The manufacture of these rosins and rosin derivatives are known to those skilled in the art, and is described in the Kirk-Othmer Encyclopedia of Chemical Technology, 4^{th} edition, vol. 21, pp. 292-297, and in the book “Naval Stores,” D. F. Zinkel and J. Russell, eds., Pulp Chemicals Association, New York, 1989, passim, especially pp. 683-694, both of which works are herein incorporated by reference. Rosin-vinylic copolymers which are suitable for use in the invention include those taught in U.S. Pat. No. 6,437,033, which is herein incorporated by reference.

Where desired, one or more non-rosin containing resinous materials can be admixed with the rosins and/or rosin derivatives—as long as the rosins and/or rosin derivatives comprise at least about 20% (preferably at least about 25%) by weight of the resinous non-volatile content of the immersing liquid dispersion or liquid solution. Additive non-rosin containing resinous materials most suitable for admixture with the rosins and/or rosin derivatives are those that are hydrophobic and that have solubility parameters similar to those of rosin acids. Suitable examples include, but are not limited to, the following: fatty acids, dimer acids, triglycerides, terpenes, phenolic resins, hydrocarbon resins, phenolic-modified terpene resins, phenolic-modified hydrocarbon resins, tall oil pitch, and combinations thereof. Particularly useful in the method of the invention are mixtures of rosin and fatty acids obtained by the distillation of tall oil.

Liquid dispersions have, by definition, both non-volatile and volatile content. In the present method, a skilled artisan will select the amount of non-volatile content contained in the liquid dispersion so as to yield the desired level of borate and resin in the final treated wood. Typically, the non-volatile content of the liquid dispersion employed in the method of the present invention is in the range of about 5% to about 65% (preferably in the range of about 6% to about 30%) by total weight of the liquid dispersion. Correspondingly, the volatile content (i.e., the water) of the aqueous liquid dispersion employed in the method of the present invention is in the range of about 35% to about 95% (preferably in the range of about 70% to about 94%) by total weight of the liquid dispersion. As used herein, the term “dispersion” includes emulsions.

In the methods of the present invention, it is preferred that the wood be immersed in the liquid dispersion at ambient temperature. Likewise, it is preferred that the dispersions of rosin and/or rosin derivatives (and, where desired, additive non-rosin containing resinous materials) be liquid at ambient temperature for utilization in the wood impregnation. In the context of the present invention, the term “ambient temperature” is typically a temperature in the range of about −25° C. to about 40° C.

Where desired, the method of the present invention can be practiced at a neutral pH. It is, therefore, preferred that the liquid dispersion of the present invention have a pH in the range of about 6.0 to about 8.0 in order to minimize potential corrosion problems with fasteners (such as nails, screws, and the like).

The preferred method for impregnating the mixtures rosins and/or rosin derivatives (and, where desired, the additive non-rosin containing resinous materials) and borates into the wood is to use an aqueous liquid dispersion or an aqueous emulsion of the rosins and/or rosin derivatives and borates. The use of an aqueous liquid dispersion or an aqueous emulsion avoids the use of a volatile organic solvent or solubilizing amine that may present environmental issues. The preparation of emulsions is discussed in the Kirk-Othmer Encyclopedia of Chemical Technology, 4^{th} edition, vol. 9, pp. 393-412 and references therein, which are incorporated herein by reference. Also useful in producing fine particle size aqueous dispersions of rosins or rosin derivatives is the miniemulsion technique taught in U.S. Pat. No. 4,177,177, which is incorporated herein by reference. Rosins, rosin derivatives, and additive non-rosin containing resinous materials mixed with the rosins and/or rosin derivative can be readily dispersed in water using conventional surfactants and high-shear mixing. These surfactants may be nonionic, cationic, anionic, or mixtures of nonionic with either anionic or cationic.

The borate can be incorporated in the liquid dispersion (or liquid emulsion) either by mixing an oil-soluble borate ester into the resinous component before emulsification or by dissolving boric acid or a water-soluble borate salt into the aqueous phase.

The pore size of woods such as pine or fir that are conventionally pressure treated for pest resistance is usually about 400-500 nm. It would be expected that the particle size of aqueous dispersions for use in the present invention should therefore be <400 nm for easy penetration of the wood. However, we have found that the particles in most rosin-based aqueous dispersions are sufficiently elastic that they can deform during the treatment process and enter the pores readily even at sizes as large as 2500 nm. Indeed, particle sizes >600 nm seem to aid in retention of the rosin-based hydrophobizing agent in the wood during pressure treatment because the particles seem to deform more readily going into the wood than they do coming out. Furthermore, larger particle size emulsions are generally easier to prepare than smaller particle size ones. They generally require less energy input and less surfactant to make. Minimizing the amount of surfactant used helps to maximize the hydrophobic nature of the treated wood. It is therefore preferred that the liquid dispersions (including liquid emulsions) of the present invention have an average particle in the range of 600 to 2500 nm, more preferably 1000 to 2000 nm.

The impregnation of the wood with the liquid dispersion that contains the borate and the rosins and/or rosin derivatives (and, where desired, the additive non-rosin containing resinous materials) can be carried out at atmospheric pressure, but it is more advantageously carried out at elevated pressure. “Loading” is a synonym for the absorption of the impregnating liquid dispersion or liquid solution by the wood and is—in the context of the present invention—also used for the respective technical impregnating process of immersing (and, preferably, applying pressure and subsequent relieving of the pressure). Methods of treating wood with chromated copper arsenate solutions and similar pesticidal mixtures at elevated pressures are well known in the art. The same equipment (e.g., pressure vessels) employed in such currently-used pesticide treatment methods can be readily adapted to the treatment of wood with the liquid dispersions of the present invention. Indeed, the wood may be immersed in any suitable vessel which can be closed to generate the given excess pressure for the loading. Likewise, pressures which are typically used for the production of chromated copper arsenate treated wood are suitable for use in the present method. A preferred pressure range is from about 50 psi to about 200 psi.

A preferred embodiment of the present invention comprises the steps of:
(i) immersing wood in a liquid dispersion, wherein the non-volatile content of the liquid dispersion comprises:
   (a) from about 10% to about 90% (preferably from about 30% to about 70%) by weight of at least one borate, and
   (b) from about 90% to about 10% (preferably from about 70% to about 30%) by weight of a resinous component comprising at least one member selected from the group consisting of rosins, rosin derivatives, and combinations thereof;
(ii) loading the immersed wood with the liquid dispersion under excess pressure for a period of time sufficient to impregnate the wood with a biocidally effective level of borate introduce a biocidally effective level of borate, thereafter relieving the excess pressure; and
(iii) removing the wood from the liquid dispersion.

A further preferred embodiment of the present invention comprises the steps of:
(i) immersing wood in a liquid dispersion, wherein the non-volatile content of the liquid dispersion comprises:
   (a) from about 10% to about 90% (preferably from about 30% to about 70%) by weight of at least one borate, and
   (b) from about 90% to about 10% (preferably from about 70% to about 30%) by weight of a resinous component comprising:
      (1) from about 20% to about 100% (preferably from about 25% to about 100%) by weight of the resinous component of at least one member selected from the group consisting of rosins, rosin derivatives, and combinations thereof, and
      (2) up to about 80% (preferably up to about 75%) by weight of the resinous component of at least one non-rosin containing resinous material;
(ii) loading the immersed wood with the liquid dispersion or under excess pressure for a period of time sufficient to impregnate the wood with a biocidally effective level of borate, thereafter relieving the excess pressure; and
(iii) removing the wood from the liquid dispersion.

The upper limit of the applicable pressure in step (b) mainly depends on the respective crushing strength of the wood, as collapsing of the wood should be avoided. It is preferred to apply a pressure in the range of about 50 psi to about 200 psi. Where desired, a vacuum may be applied during step (b) to support the efficiency of the loading.

Pesticidal wood treatments currently in use, such as CCA and ACQ, impart a color to the wood due to the nature of the metal ions present. This color also serves as a convenient indication for the consumer that the wood has been so treated. Where desired, at least one dye and/or pigment can be added to the liquid dispersions and liquid solutions of the present invention in order to impart a color to the resulting wood to serve as a similar indicator. A combination of lignin and a green pigment such as chlorinated copper phthalocyanine is particularly effective in mimicking the color of CCA-treated wood. The use of light-fugitive dyes may be particularly advantageous in this application; as the use of such dyes permits the wood to be colored for identification but, once the wood is in place in or on an outdoor structure, the exposure to sunlight will bleach the dye and the wood will revert to its natural color.

The following examples are provided to further illustrate the present invention and are not to be construed as limiting the invention in any manner.

### EXAMPLE 1

A liquid dispersion (aqueous emulsion) of the present invention containing rosin and boric acid was prepared as follows. Seven hundred twenty grams of boric acid was dissolved in 15,696 grams of deionized water. Fourteen hundred forty grams of distilled tall oil and 144 grams of Igepal CO-887 (a nonionic surfactant supplied by Rhodia) were weighed into a five-gallon bucket and blended well with a slow-speed mixer. Stirring was continued while 750 ml of the boric acid solution was slowly added to the tall oil mixture. The crude emulsion formed was then homogenized for 15 minutes in a Ross Model ME100L Homogenizer at a #4 setting. The homogenized emulsion was then diluted with the remainder of the boric acid solution.

A piece of 5/4×6-inch yellow pine decking was placed in a cylindrical pressure vessel and subjected to a vacuum for twenty minutes. Then the above diluted emulsion was introduced into the vessel at ambient temperature, immersing the wood. The vessel was pressurized to 150 psi for thirty minutes. Thereafter the pressure was released, the wood was removed from the pressure vessel, and the water in the wood was allowed to evaporate to yield a water-resistant, borate-treated decking plank.

### EXAMPLE 2

Four hundred grams of boric acid was dissolved in 9,160 grams of deionized water. Fifty six grams of RESIN 95 (a disproportionated rosin commercially available from MeadWestvaco Corp.), 344 grams of M28B (a distilled tall oil product comprising about 28 weight-% rosin and about 72 weight-% fatty acid commercially available from MeadWestvaco Corp.), and 40 grams of Igepal CA-897 (a nonionic surfactant commercially available from Rhodia) were weighed into another container and thoroughly mixed. The boric acid solution was slowly added with stirring to the rosin-containing mixture, and the resulting emulsion was homogenized for five minutes using a Ross Model ME100L Homogenizer.

A piece of 5/4×6-inch yellow pine decking was placed in a cylindrical pressure vessel and subjected to a vacuum for twenty minutes. Then the above emulsion was introduced into the vessel at ambient temperature, immersing the wood. The vessel was pressurized to 150 psi for thirty minutes. Thereafter the pressure was released, the wood was removed from the pressure vessel, and the water in the wood was allowed to evaporate to yield a water-resistant, borate-treated decking plank.

A four foot long plank treated in the above manner was subjected to an accelerated weathering test by mounting it outdoors, spraying it with water equivalent to 6.5 inches of rainfall/hour for two three-hour periods each day, and allowing it to dry between sprayings. Six weeks of this treatment is equivalent to 10 years of normal outdoor exposure in the Southeastern United States. During six weeks of testing, the boron content of the plank fell from an initial value of 4,133 ppm to 2,900 ppm (70% of the original value). A similar plank pressure treated with borate but not including the rosin/fatty acid mixture showed a boron content reduction in six weeks from 3,342 ppm to 927 ppm (28% of the original value). Thus it can be seen that the rosin-based resin mixture substantially reduced the leaching of the borate. It is generally accepted in the wood treating industry that 0.17 lb/ft³ of B₂O₃ or 1,350 ppm of boron in the wood represents the minimum level of borate needed effectively to kill termites. Therefore, it can be seen that after ten years equivalent of accelerated aging the wood with the rosin-based treatment exceeds this level by a factor of more than 2, whereas the wood treated with borate alone is substantially below the pesticidally effective threshold.

### EXAMPLE 3

Seven hundred twenty grams of boric acid was dissolved in 14,752 grams of deionized water. Sixty-seven grams of RESIN 95 (a disproportionated rosin commercially available from MeadWestvaco Corp.), 413 grams of M28B (a distilled tall oil product comprising about 28 weight-% rosin and about 72 weight-% fatty acid commercially available from MeadWestvaco Corp.), 24 grams of Igepal CO-630 (a nonionic surfactant commercially available from Rhodia), and 24 grams of Igepal CA-897 (a nonionic surfactant commercially available from Rhodia) were weighed into another container and thoroughly mixed. The boric acid solution was slowly added with stirring to the rosin-containing mixture, and the resulting emulsion was homogenized for five minutes using a Ross Model ME100L Homogenizer.

A piece of 5/4×6-inch yellow pine decking was placed in a cylindrical pressure vessel and subjected to a vacuum for twenty minutes. Then the above emulsion was introduced into the vessel at ambient temperature, immersing the wood. The vessel was pressurized to 150 psi for thirty minutes. Thereafter the pressure was released, the wood was removed from the pressure vessel, and the water in the wood was allowed to evaporate to yield a water-resistant, borate-treated decking plank.

A four foot long plank treated in the above manner was subjected to an accelerated weathering test by mounting it outdoors, spraying it with water equivalent to 6.5 inches of rainfall/hour for two three-hour periods each day, and allowing it to dry between sprayings. Six weeks of this treatment is equivalent to 10 years of normal outdoor exposure in the Southeastern United States. Samples of the weathered wood were tested for resistance to Formosan termites at the Louisiana Forest Products Development Center. On a scale of 1-10 (with 10 being complete resistance and 1 being complete destruction of the wood), the samples were rated 9.1 versus 9.6 for CCA-treated wood and 1.1 for untreated yellow pine. The difference between 9.1 and 9.6 in this test is not statistically significant.

### EXAMPLE 4

A liquid dispersion (aqueous emulsion) of the present invention comprising 8 parts by weight of distilled tall oil, 4 parts by weight of boric acid, 0.8 parts by weight of Igepal CA-897 (a nonionic surfactant commercially available from Rhodia), and 87.2 parts by weight water was prepared by the procedure described in Example 2. To 250 grams of this emulsion was added with stirring 0.015 gram of GFD-1151 (a phthalocyanine green pigment dispersion commercially available from the Pigment Division of Sun Chemical Co.) and 1.75 grams of Indulin W-1 (a kraft lignin product commercially available from MeadWestvaco).

A piece of yellow pine was pressure treated with the resulting mixture following the procedure described in Example 1. The resulting piece of treated wood had the greenish-brown appearance of wood treated with CCA.

Many modifications and variations of the present invention will be apparent to one of ordinary skill in the art in light of the above teachings. It is therefore understood that the scope of the invention is not to be limited by the foregoing description, but rather is to be defined by the claims appended hereto.

1. A method for producing an insect- and soil microbe-resistant wood comprising the step of immersing an insect- and soil microbe-susceptible wood in a liquid dispersion for a period of time sufficient to impregnate the wood with a biocidally effective level of borate, wherein the non-volatile content of the liquid dispersion comprises:
(a) from about 10% to about 90% by weight of at least one borate, and
(b) from about 90% to about 10% by weight of a resinous component comprising at least one member selected from the group consisting of rosin, rosin derivatives, and combinations thereof.

2. The method of claim 1 wherein the non-volatile content of the liquid dispersion is in the range of about 5% to about 65% by total weight of the liquid dispersion, and the volatile content of the liquid dispersion is in the range of about 35% to about 95% by total weight of the liquid dispersion.

3. The method of claim 1 wherein the non-volatile content of the liquid dispersion is in the range of about 6% to about 30% by total weight of the liquid dispersion, and the volatile content of the liquid dispersion is in the range of about 70% to about 94% by total weight of the liquid dispersion.

4. The method of claim 1 wherein the non-volatile content of the liquid dispersion comprises:
(a) from about 30% to about 70% by weight of at least one borate, and
(b) from about 70% to about 30% by weight of a resinous component comprising at least one member selected from the group consisting of rosin, rosin derivatives, and combinations thereof.

5. The method of claim 1 wherein the resinous component (b) comprises:
(a) from about 20% to 100% by weight of at least one member selected from the group consisting of rosins, rosin derivatives, and combinations thereof, and
(b) up to about 80% by weight of at least one non-rosin containing resinous material.

6. The method of claim 5 wherein the resinous component (b) comprises:
(a) from about 25% to 100% by weight of at least one member selected from the group consisting of rosins, rosin derivatives, and combinations thereof, and
(b) up to about 75% by weight of at least one non-rosin containing resinous material.

7. The method of claim 5 where the non-rosin containing resinous material is a member selected from the group consisting of fatty acids, dimer acids, triglycerides, terpenes, phenolic resins, hydrocarbon resins, phenolic-modified terpene resins, phenolic-modified hydrocarbon resins, tall oil pitch, and combinations thereof.

8. The method of claim 1 wherein the wood is a wood part.

9. The method of claim 8 wherein the wood part is a member selected from the group consisting of decking, fencing, facia boards, plywood, laminated lumber, chipboard, strandboard, construction elements for outdoor furniture, and construction elements for outdoor furniture playground equipment.

10. The method of claim 1 wherein the borate is a member selected from the group consisting of boric acid, borate salts, borate esters, and combinations thereof.

11. The method of claim 1 wherein the rosin is a member selected from the group consisting of tall oil rosin, gum rosin, wood rosin, and combinations thereof.

12. The method of claim 1 wherein the rosin derivative is a member selected from the group consisting of hydrogenated rosins, disproportionated rosins, formaldehyde-treated rosins, dimerized rosins, polymerized rosin, fumarated rosins, maleated rosins, styrenated rosins, phenolic-modified rosins, acrylic-modified rosins, hydrocarbon-modified rosins, rosin-vinylic copolymers, rosin salts, hydrogenated rosin salts, disproportionated rosin salts, formaldehyde-treated rosin salts, dimerized rosin salts, polymerized rosin salts, fumarated rosin salts, maleated rosin salts, styrenated rosin salts, phenolic-modified rosin salts, acrylic-modified rosin salts, hydrocarbon-modified rosin salts, rosin-vinylic copolymer salts, rosin esters, hydrogenated rosin esters, disproportionated rosin esters, formaldehyde-treated rosin esters, dimerized rosin esters, polymerized rosin esters, fumarated rosin esters, maleated rosin esters, styrenated rosin esters, phenolic-modified rosin esters, acrylic-modified rosin esters, hydrocarbon-modified rosin esters, rosin-vinylic copolymer esters, rosin amides, hydrogenated rosin amides, disproportionated rosin amides, formaldehyde-treated rosin amides, dimerized rosin amides, polymerized rosin amides, fumarated rosin amides, maleated rosin amides, styrenated rosin amides, phenolic-modified rosin amides, acrylic-modified rosin amides, hydrocarbon-modified rosin amides, rosin-vinylic copolymer amides, and combinations thereof.

13. The method of claim 1 wherein the liquid dispersion is an aqueous emulsion.

14. The method of claim 13 wherein the aqueous emulsion further comprises at least one surfactant.

15. The method of claim 1 wherein the liquid dispersion has an average particle size of from about 600 to about 2500 nanometers.

16. The method of claim 1 wherein the liquid dispersion has an average particle size of from about 600 to about 2500 nanometers.

17. The method of claim 1 wherein the liquid dispersion has an average particle size of from about 1000 to about 2000 nanometers.

18. The method of claim 1 wherein the liquid dispersion further comprises at least one member selected from the group consisting of dyes, pigments, and combinations thereof.

19. A method for producing an insect- and soil microbe-resistant wood comprising the steps of:
(i) immersing an insect- and soil microbe-susceptible wood in a liquid dispersion, wherein the non-volatile content of the liquid dispersion:
(a) from about 10% to about 90% by weight of at least one borate, and
(b) from about 90% to about 10% by weight of a resinous component comprising at least one member selected from the group consisting of rosin, rosin derivatives, and combinations thereof,
(ii) loading the immersed wood with the liquid dispersion under excess pressure for a period of time sufficient to impregnate the wood with a biocidally effective level of borate, thereafter relieving the excess pressure; and
(iii) removing the wood from the liquid dispersion.

20. The method of claim 19 wherein the resinous component (i) (b) comprises:
(1) from about 20% to 100% by weight of at least one member selected from the group consisting of rosins, rosin derivatives, and combinations thereof, and
(2) up to about 80% by weight at least one non-rosin containing resinous material.

21. The method of claim 19 wherein the resinous component (i) (b) comprises:
(1) from about 25% to 100% by weight of at least one member selected from the group consisting of rosins, rosin derivatives, and combinations thereof, and
(2) up to about 75% by weight at least one non-rosin containing resinous material.

22. The method of claim 19 where the non-rosin containing resinous material is a member selected from the group consisting of fatty acids, dimer acids, triglycerides, terpenes, phenolic resins, hydrocarbon resins, phenolic-modified terpene resins, phenolic-modified hydrocarbon resins, tall oil pitch, and combinations thereof.

23. The method of claim 19 wherein a vacuum is applied during step (ii).

24. The method of claim 19 wherein a pressure in the range of about 50 psi to about 200 psi is applied in step (ii).

25. The impregnated wood as prepared by the method of claim 1.

26. The impregnated wood as prepared by the method of claim 19.
